(19) United States
(12) Patent Application Publication
(10) Pub. No.: US 2026/0268286 A1
(43) Pub. Date: Sep. 10, 2026

(54) ELECTROMECHANICAL APPARATUS, SYSTEM FOR REGENERATING SUCH AN APPARATUS AND CORRESPONDING METHOD

(71) Applicant: DEGLACE, Lille (FR)

(72) Inventors: Matthieu DE WOLF, Paris (FR); Geoffroy HULOT, Lille (FR)

(21) Appl. No.: 19/165,787

(22) PCT Filed: Mar. 21, 2024
(86) PCT No.: PCT/EP2024/057571

§ 371 Date: Sep. 16, 2025

(30) Foreign Application Priority Data
Mar. 22, 2023 (FR) FR2302703

(51) Int. Cl. G06Q 10/20; A47L 5/12; A47L 9/12; A47L 9/28; H01M 10/48; H01M 50/247

(52) U.S. Cl. CPC G06Q 10/20; A47L 5/12; A47L 9/12; A47L 9/2831; A47L 9/2857; A47L 9/2884; A47L 9/2889; A47L 9/2894; H01M 10/486; H01M 10/488; H01M 50/247; H01M 2220/30

(57) ABSTRACT

An electromechanical device, such as a stick vacuum cleaner, a regenerating system and methods are disclosed. The electromechanical device includes a central structure in which at least one electronic device is assembled and, electrically connected to at least one electromechanical device. The at least one electronic device being capable of supplying electrical power and controlling said at least one electromechanical device. These devices are arranged in the form of modules assembled in the central structure and are electrically or functionally connected to each other without tools and in such a way as to be directly operational after their assembly in the central structure.

### TECHNICAL FIELD

The invention relates generally to the technical field of electromechanical devices, such as power tools, electric vehicles or household appliances.

The invention relates in particular to household appliances comprising a battery supplying power to an electromechanical device, such as an electric motor.

The invention applies in particular to electromechanical devices such as vacuum cleaners and, more specifically, stick vacuum cleaners.

### PRIOR ART

In the following description, the longitudinal direction and transverse direction are understood to mean the directions parallel and perpendicular to the main axis of the electromechanical appliance (i.e. the axis corresponding to the largest dimension of the appliance), for example the main axis of a stick vacuum cleaner. The same applies to the front and rear or the top and bottom, which are oriented according to the normal position of use of the electromechanical device described, for example the position of use of a stick vacuum cleaner.

In order to facilitate the reader's understanding of the invention, the description of the invention in the remainder of the description is based purely for illustrative purposes on a stick vacuum cleaner. However, it is understood that the invention may be implemented in other forms of electromechanical devices, such as household appliances, or in the form of power tools such as a drill.

It is known in the prior art that stick vacuum cleaners comprise a main structure acting as a frame, a lower part of which comes into contact with the floor to be vacuumed and an upper part is held by a user in such a way that the main axis of the main structure of the stick vacuum cleaner is inclined rearwardly with respect to the vertical. The main structure of the broom vacuum cleaner generally has an elongated shape, the lower part of which is formed by a suction tube connected at its lower end to a brush device that comes into contact with the floor. The upper end of the suction tube is connected to a substantially cylindrical vacuum cleaner body to which a handle is mechanically connected, allowing the vacuum cleaner to be held by a user. The handle may comprise devices for controlling the vacuum cleaner's functions in the form of push buttons or switches. The vacuum cleaner body is hollow so that it can house a number of electronic components, such as a battery and devices for controlling the operation of the vacuum cleaner, electromechanical devices, such as an electric motor mechanically connected to a suction device, for example a propeller, and mechanical devices, such as filters, for example a main filter downstream of the motor and a fabric filter generally located between the main filter and the motor to protect the motor from dust not captured by the cyclone filter. The main filter is generally located in a hollow, removable part of the vacuum cleaner body that acts as a dust container to collect dust sucked up from the floor.

When the vacuum cleaner is in operation, dust accumulates in the tank and when it is too full, the dust can form a blockage that obstructs the air flow, which significantly reduces the suction power and can damage the motor if the tank is not emptied regularly. For the same reasons, the various filters in the vacuum cleaner must be cleaned regularly to remove fine dust that clogs them and reduces suction power, as explained above.

However, vacuum cleaner users often forget to carry out these maintenance operations regularly, which over time can damage the motor and cause the vacuum cleaner to break down. Furthermore, it is not always easy for users to carry out the necessary maintenance operations, especially if they are not experts in this field.

After a certain number of charging cycles or recharging the battery under poor conditions, the battery deteriorates and its charging capacity decreases, reducing the vacuum cleaner's operating time. A significant reduction in the vacuum cleaner's operating time renders it unusable in practice, and the battery must be replaced to restore the vacuum cleaner's operating time.

In all these situations, the vacuum cleaner will need to be repaired. However, this requires technical expertise and tools, which usually means calling in a professional repairer. As a result, the hassle and cost of repair often lead the owner of the vacuum cleaner to throw it away instead of repairing it.

In general, dust accumulation and pollution caused by dust are a major problem that needs to be addressed in the field of electromechanical appliances, particularly household appliances such as vacuum cleaners and others. Dust can infiltrate various components of such equipment and degrade their performance, or even cause breakdowns or reduce the reliability of these appliances. This degradation results in what is known as “usage” obsolescence.

In addition, such equipment is susceptible to shocks, for example during use or handling. These shocks can cause breakdowns or impair the performance or reliability of the appliance.

Furthermore, technological obsolescence is a major challenge for electromechanical devices, particularly for power tools and household appliances such as vacuum cleaners, drills and other devices. Technologies tend not to be compatible with each other, which leads to interoperability problems for certain components and makes it difficult to maintain and upgrade devices, particularly in relation to technological developments and market needs.

There is therefore a need for an electromechanical device, such as a household appliance, such as a vacuum cleaner or other device, which is easy to maintain and/or upgrade by a non-expert while preserving the performance and reliability (in particular the longevity) of the device, in particular to combat obsolescence (obsolescence of use and technological obsolescence) of such a device. In particular, there is a need for such a device that can be easily repaired by its user when necessary.

### DESCRIPTION OF THE INVENTION

The present invention aims to remedy all or part of the disadvantages of the prior art by offering, in particular, an electromechanical device, such as a household appliance, for instance a stick vacuum cleaner, whose electronic and electromechanical devices can be easily replaced at the appropriate time (e.g. before or during a breakdown) while maintaining the performance and reliability of the device. To this end, the performance of the device can, in particular, be monitored during use to prevent breakdowns due to insufficient maintenance.

To this end, according to a first aspect of the invention, an electromechanical appliance is proposed comprising a central structure in which at least one electronic device electrically connected to at least one electromechanical device is assembled, said at least one electronic device enabling the supply of electrical energy and/or control of said at least one electromechanical device. In the electromechanical device, the at least one electronic device and the at least one electromechanical device are respectively arranged in the form of at least one removable electronic module and at least one removable electromechanical module. The at least one electronic module and the at least one electromechanical module each comprise each respectively a control device for the electronic device and the electromechanical device, integrated into the module. The at least one electronic module and the at least one electromechanical module are assembled in the central structure and are electrically connected to each other without tools and in such a way that they are directly operational after assembly.

According to one embodiment, the central structure forms (or acts as) a chassis in which the at least one electronic device and the at least one electromechanical device are assembled.

According to one embodiment, the at least one electronic module and the at least one electromechanical module are each equipped with at least one sensor capable of measuring performance of the corresponding at least one module. The control devices integrated into the modules can be configured to implement, based on the performance measurements, diagnostic and predictive functions that generate an alert signal when the performance of the corresponding module measured by the at least one sensor does not comply with predefined values or is non-compliant according to an algorithm that can integrate a learning function; and to transmit said alert signal to a signalling device for signalling a status of said module.

Thus, performance measurements can be processed by the control device, integrated into the modules, which comprises diagnostic and predictive functions, in order to generate an alert signal when the performance of the corresponding module measured by the sensors does not comply with standard values or is non-compliant according to an algorithm that can incorporate a learning function. The alert signal can be transmitted to a device for signalling the status of the module.

According to one embodiment, the alert signal represents at least one of the following: a first state requiring maintenance, a second state requiring fault prevention, and/or a third state requiring fault repair.

According to one embodiment, the signalling device comprises at least one of: a screen located on the electromechanical device and electrically connected to the at least one electronic module; and a transceiver for establishing a wireless connection with a third-party terminal independent of the electromechanical device, such as a tablet or smartphone, and/or a server capable of generating a notification from a dedicated application and/or by email.

Advantageously, the electromechanical device further comprises at least one mechanical module assembled to the central structure so as to be functionally connected to the at least one electronic module without tools and so as to be directly operational after assembly.

According to one embodiment, the electromechanical device is a power tool, a means of individual transport, or a household appliance; and in which the at least one electronic module comprises a battery module comprising a rechargeable battery, and in which the at least one electromechanical module comprises a motor module comprising an electric motor device powered electrically by the battery module.

According to one embodiment, the electromechanical device further comprises at least one mechanical module assembled in the central structure so as to be functionally connected to the at least one electromechanical module without tools and so as to be directly operational after assembly.

According to one embodiment, the electromechanical device is such that:
the at least one electronic module, the at least one electromechanical module and the at least one mechanical module are assembled in the central structure and are electrically or functionally connected to each other without tools and in such a way as to be directly operational after their assembly in the central structure; and
the at least one electronic module is configured to supply power to the device; and
said at least one mechanical module comprises at least one filter module.

According to one embodiment, the electromechanical device is a stick vacuum cleaner.

According to one embodiment, the electromechanical device is such that:
said at least one sensor of the battery module is configured to measure a temperature or charge capacity of the battery;
said at least one sensor of the motor module is configured to measure a temperature or rotation speed of the electric motor; and
said signalling device is configured to generate, in response to said alert signal, an alert in the form of a pictogram or a notification.

According to one embodiment, the electromechanical device is such that:
the first state requires a maintenance operation for which a user is prompted to access the affected module to perform a maintenance operation, such as emptying a dust container and cleaning the at least one filter when the at least one sensor of the motor module detects an over-speed;
the second state requires a fault prevention operation for which the user is prompted to order a replacement battery module to replace the faulty battery module before it becomes inoperable, when the at least one sensor of the motor module detects an under-speed of the electric motor, or to order a replacement motor module to replace the faulty battery module, if the at least one sensor of the motor module detects overheating of the electric motor; and
the third state requires a repair operation to restore full functionality to a faulty module.

According to one embodiment, the electromechanical device further comprises a PCB card arranged in a housing provided in said central structure and having at least one front connector on a front face and at least one rear connector on a rear face. The motor module is inserted from the front into the housing to connect to the at least one front connector of the PCB board, and/or the battery module is inserted into the housing from the rear to connect to the at least one rear connector of the PCB board. Thus, the PCB centralises (or processes) information, including performance measurements, coming from (or received from) the battery and motor modules, and transmits each alert signal to the signalling device.

According to one embodiment, the electromechanical device is such that:
the screen is electrically connected to the central PCB board, arranged on the stick vacuum cleaner, preferably on a visible part of the battery module once it is inserted into the housing, and on which the status of the stick vacuum cleaner is indicated by pictograms; and/or
the wireless transceiver is electrically connected or integrated with the PCB board and electrically connected to an antenna located on the main structure, preferably in a handle, in order to communicate with a third-party terminal.

According to a second aspect of the invention, a regeneration system (also referred to as a system) is proposed, comprising an electromechanical device according to the first aspect of the invention and a third-party terminal, for example a computer, smartphone or tablet, on which an application is installed. The application (executed by the third-party terminal) is configured to receive a said alert signal, produced from the performance measurements, via wireless communication, and to command the said third-party terminal to generate a first notification to a user, and/or a second notification transmitted by the said third-party terminal, for example on a user profile of a website and/or in a user's mailbox.

The regeneration system according to the second aspect can thus enable the regeneration of the electromechanical device as defined above, for example a stick vacuum cleaner. Thus, if the performance of the respective module does not comply with predefined standard values or is non-compliant according to an algorithm that can integrate a learning function, then the application can receive the alert signal wirelessly from the third-party terminal and generate, in response to the alert signal, a first notification to a user. Alternatively or cumulatively, a second notification may be transmitted by the third-party terminal, for example to a user profile on a dedicated website and to the user's email inbox.

According to one example of implementation, if the alert signal corresponds to a first condition requiring maintenance, the application provides the user with a tutorial procedure (or tutorial information, or usage information) on the third-party terminal for servicing or maintaining the electromechanical device.

According to one embodiment, if the alert signal corresponds to a second state requiring a fault prevention operation, the application allows the user to order a replacement module (possibly via a dedicated website).

According to one embodiment, if the alert signal corresponds to a third state requiring a fault repair operation, the application authorises the user to order a replacement module (possibly via a dedicated website).

According to one example of implementation, the regeneration system is such that:
the application is configured to provide a user with access, through the application, to a configuration panel of the electromechanical device to enter information relating to a context of use of the electromechanical device, and to configure the electromechanical device by selecting modules adapted to the context of use; and/or
the application is configured to cause information relating to a nominal usage warranty for at least one said module to be stored.

Thus, the user can conveniently access a control panel for the electromechanical device or the stick vacuum cleaner via the dedicated app and/or the dedicated website to enter information relating to its context of use in order to configure it by selecting modules suited to the context of use. Information relating to a nominal use warranty for all available battery, motor or mechanical modules is stored on the dedicated application and/or the dedicated website.

According to a third aspect of the invention, a method (or regeneration method) is proposed for implementing the system according to the second aspect of the invention, to enable the regeneration of an electromechanical device as defined above. In other words, this method is implemented by the system of the second aspect of the invention.

The method according to the fourth aspect comprises:
providing a user with access to a configuration panel of said electromechanical device on said third-party terminal through said application;
obtaining, via the configuration panel, information relating to the context of use of said electromechanical device; and
determining, by the application, based on the information relating to the context of use, a configuration of said electromechanical device by identifying, among available electronic and electromechanical modules, the at least one electronic module and the at least one electromechanical module that are most appropriate according to the context of use, for example, the battery module whose autonomy is best suited to the context of use of the said electromechanical device.

This allows a user to conveniently access a configuration panel for their product on the third-party terminal via the dedicated app. The user enters information relating to the context of use of the said household appliance or the said stick vacuum cleaner. This information enables the dedicated application to identify the configuration of the said household appliance or the said stick vacuum cleaner by identifying, from the range of available electronic or electromechanical modules, those that are most appropriate for its use, for example, the battery module with the autonomy best suited to the context of use of the said household appliance or stick vacuum cleaner, and, thanks to its modular design, to offer the household appliance or stick vacuum cleaner best suited to its use.

According to one example of implementation, the method comprises, during operation of the electromechanical appliance:
performing performance measurements of the at least one electronic module, such as the battery module, and the at least one electromechanical module, such as the motor module, by the sensor equipping each of these modules;
generating an alert signal by said sensor if the performance of the corresponding module does not comply with predefined values or is non-compliant according to an algorithm that may incorporate a learning function; and
transmitting said alert signal to a device for signalling the status of the electromechanical appliance.

According to one embodiment, the alert signal is transmitted to a screen located on the electromechanical device and/or to an application installed on a third-party terminal, so as to enable the display of at least one of the following:
a first state requiring a maintenance operation for which a user is prompted to access the affected module to perform a maintenance operation, a tutorial procedure is provided to assist the user in performing the operation,
a second state requiring a fault prevention operation for which the user is prompted to order a replacement module on the application to replace the faulty module, and
a third state requiring a breakdown repair operation for which the user must order a replacement module on the application to replace the faulty module.

The alert signal can thus be conveniently transmitted to a screen located on the electromechanical device or vacuum cleaner and/or a dedicated application installed on a third-party terminal. This makes it possible to view the different statuses of the electromechanical device or vacuum cleaner. A first status requiring maintenance, for which the user is prompted to access the affected module to perform maintenance, with a tutorial procedure provided to assist the user in performing the operation. A second status requiring a fault prevention operation, for which the user is invited to order a replacement module on the dedicated application to replace the faulty module. A third status requiring a fault repair operation, for which the user must order a replacement module on the dedicated application to replace the faulty module.

According to a fourth aspect of the invention, a computer program product is proposed comprising code instructions for implementing all or part of the method according to the third aspect of the invention as defined above. This computer program can in particular be executed collectively by the electromechanical device and the third-party terminal of the system according to the second aspect of the invention, as defined above.

This computer program may use any programming language and be in the form of source code, object code, or intermediate code between source code and object code, such as in a partially compiled form, or in any other desirable form.

The invention also relates to a computer-readable information carrier (or recording medium) comprising instructions for a computer program as mentioned above.

The present invention advantageously provides an electromechanical device, such as a household appliance or other device, for example a stick vacuum cleaner, whose maintenance and/or upgradeability are easy for a non-expert while preserving the performance and reliability (in particular the longevity) of the device. In this way, the obsolescence of such an appliance can be effectively combated, whether it be obsolescence due to use or technological obsolescence, as already indicated. In particular, it is possible for a user to easily repair or improve part of the electromechanical appliance (e.g. a defective part or a part that they wish to modify) at the appropriate time, for example, preventively before performance degradation or before a breakdown occurs, or curatively when a breakdown or defect occurs, or when the performance of the device is no longer suitable for the context of use.

For example, in the case of a stick vacuum cleaner, its performance can be advantageously improved by modifying a module, such as the battery module and/or motor module, in order to meet new usage requirements (e.g. a new usage environment requiring adaptation of the performance of the module(s)). A non-expert user can thus easily ensure the upgradeability of the electromechanical device by replacing one or more modules assembled in the central structure.

The modular construction within the central structure also provides effective protection for the modules of the electromechanical device, in particular against dust and shocks, while allowing each module to be replaced independently, so that maintenance and/or upgrades can be carried out as required.

The invention can also be advantageously used to detect faults, breakdowns or any performance drops (transient or prolonged) in the modules of the electromechanical device, thereby enabling even non-expert users to determine which module needs to be replaced and when (e.g. before or after a breakdown or other event). Maintenance operations can, for example, be announced preventively or curatively so that the user can identify and, if necessary, replace the appropriate module with another at the appropriate time.

Other features and advantages of the invention are highlighted in the following description of non-limiting examples of embodiments of various aspects of the invention.

### BRIEF DESCRIPTION OF THE FIGURES

The description refers to the accompanying figures, which are also provided as non-limiting examples of embodiments of the invention:

FIG. 1 shows an exploded side view of a stick vacuum cleaner;

FIG. 2 shows an exploded side perspective view of the vacuum cleaner body and its components;

FIG. 3 shows the interior of the vacuum cleaner body in top view;

FIG. 4 shows a side perspective view of the assembly of the internal components of the vacuum cleaner body; and

FIG. 5 illustrates the different phases of the process as viewed on a smartphone.

For clarity, identical or similar elements are identified by identical reference signs throughout the figures.

### DETAILED DESCRIPTION OF AN EMBODIMENT

For illustrative purposes only, the description of embodiments of the invention in the following description is based on a stick vacuum cleaner. However, it is understood that the invention is not limited to this particular example and may be implemented in other forms of electromechanical devices, such as household appliances, or in the form of power tools such as a drill. Many details of the implementation are provided below as non-limiting examples, but other implementations are possible.

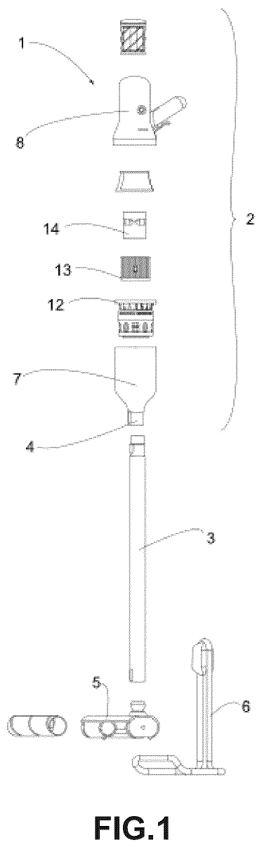

FIG. 1 shows an electromechanical device in the form of a stick vacuum cleaner 1, together with its various components, according to one embodiment of the invention. The stick vacuum cleaner 1 comprises a vacuum cleaner body 2 which is the main structure of the stick vacuum cleaner. The body 2 comprises a central structure 8 which acts as the frame of the stick vacuum cleaner 1. This central structure 8 forms, for example, a shell or equivalent.

Particular examples of the stick vacuum cleaner 1 are described below with reference to FIGS. 1 to 5.

The stick vacuum cleaner 1 comprises at least one electronic device electrically connected to at least one electromechanical device. The at least one electronic device and the at least one electromechanical device are assembled in the central structure 8. These modules are arranged in the form of removable modules within the central structure 8, which means that they can be removed from the central structure 8 after being assembled therein. Thus, the at least one electronic device and the at least one electromechanical device are respectively arranged in the form of at least one removable electronic module and at least one removable electromechanical module in the central structure 8. Once assembled, these modules are thus protected inside the central structure 8 serving as the frame of the stick vacuum cleaner.

The number and characteristics of the electronic and electromechanical modules may vary depending on the case. By way of example, it is assumed below that the stick vacuum cleaner 1 comprises, in the central structure 8, an electronic module and an electromechanical module corresponding (or comprising) respectively to a battery module 21 and a motor module 14, although other examples are possible.

The at least one electronic module and the at least one electromechanical module are assembled in the central structure 8 and are electrically connected to each other without tools and in such a way that they are directly operational after assembly.

In this document, an element is said to be inserted, connected, etc. “without tools” if it is inserted, connected, etc. manually without tools, i.e. without using hand tools or mechanical tools. For example, no fastening tools (screws, bolts, etc.) or handling tools (screwdrivers, wrenches, etc.) are used or required.

In this document, connecting or inserting an element without tools in such a way that it is “directly operational” (or functional) after assembly means that once connected or inserted manually, the element is connected in an operative manner, i.e. in such a way that it can function (or cooperate) in synergy with the element(s) to which it is connected or into which it is inserted. To this end, as described below in particular examples, locking devices may be arranged on each element intended to be connected so that the locking devices on both sides cooperate together to lock manually and, if necessary, unlock manually, for example according to a “plug & play” locking mechanism.

The at least one electronic module and the at least one electromechanical module, namely the battery module 21 and the motor module 14 in the following examples, each comprise a respective control device for said module, integrated in said module. In other words, the electromechanical module comprises its own control device integrated into said electromechanical module, and the electronic module comprises its own control device integrated into the electronic module.

The battery module 21 can be configured to electrically power the motor module 14 once these two modules are assembled together in the central structure 8. More generally, the electronic module can be configured to provide power to the stick vacuum cleaner 1. To do this, the battery module 21 includes, for example, a rechargeable battery.

The motor module 14 includes, for example, an electric motor device 17 powered by the battery module 21.

According to a particular example, the at least one electronic module (i.e. the battery module 21, for example) and the at least one electromechanical module (i.e. the motor module 14, for example) are each equipped with at least one sensor configured to measure the performance (or characteristics, or capabilities) of the at least one corresponding module.

As described below in particular examples, the nature, characteristics and number of the measured performances may vary depending on the case, in particular depending on the type of sensors used and the performances to be monitored. For example, a sensor of the battery module may be configured to measure a temperature (representative of the safety and performance of the battery) or a charge capacity of the battery of the battery module. For example, a sensor in motor module 14 may be configured to measure a temperature, rotation speed (e.g. under-speed or over-speed) and/or vibrations (e.g. related to mechanical faults) of an electric motor in motor module 14.

The control devices integrated respectively into the electronic module and the electromechanical module can then be configured to implement diagnostic and predictive functions based on performance measurements, generating an alert signal when the performance of the corresponding module measured by the sensors does not comply with predefined values (e.g. standard values). An algorithm incorporating a learning function may be executed by each control device for this purpose. The control devices may also be configured to transmit each alert signal to a signalling device. This signalling device can then generate or determine a status of the corresponding module based on an alert signal received. Each alert can be rendered or delivered by the signalling device in any appropriate form, for example in the form of pictograms and/or notifications.

As described below in particular examples, an alert signal generated by one of the control devices may represent various states of the module concerned by the alert, as appropriate.

According to a particular example, the vacuum cleaner 1 further comprises at least one mechanical module (see, for example, references 12, 13, 22 described below) assembled in the central structure 8 so as to be functionally connected to the at least one electromechanical module (namely the motor module 14) without tools and in such a way as to be directly operational after assembly. For example, the at least one mechanical module assembled in the central structure 8 includes at least one filter module (or filter block), as described below in particular examples.

In this case, the electronic module, the electromechanical module (namely the motor module 14), the electronic module (namely the battery module 21) and the mechanical module can be assembled in the central structure 8 in the form of removable modules and are electrically or functionally connected to each other without tools and in such a way as to be directly operational after their assembly in the central structure 8. In this case, the mechanical module may also include its own control device configured in a similar way to the control devices of the electromechanical module and the electronic module.

Particular examples of the vacuum cleaner 1 and some of its elements mentioned above are now described with reference to FIGS. 1 to 5.

According to a particular example illustrated in FIG. 1, the upper end of a suction tube 3 can be inserted into a cylindrical opening 4 formed at the lower part of the vacuum cleaner body 2. A brush device 5 can be mechanically connected to the lower part of the suction tube 3. When not in use, the stick vacuum cleaner 1 can be stored on a base 6. The base 6 may be connected to a domestic electrical socket and may comprise electrical base contacts (not shown) which are electrically connected to electrical vacuum cleaner contacts (not shown) to enable the stick vacuum cleaner 1 to be recharged when stored on its base 6.

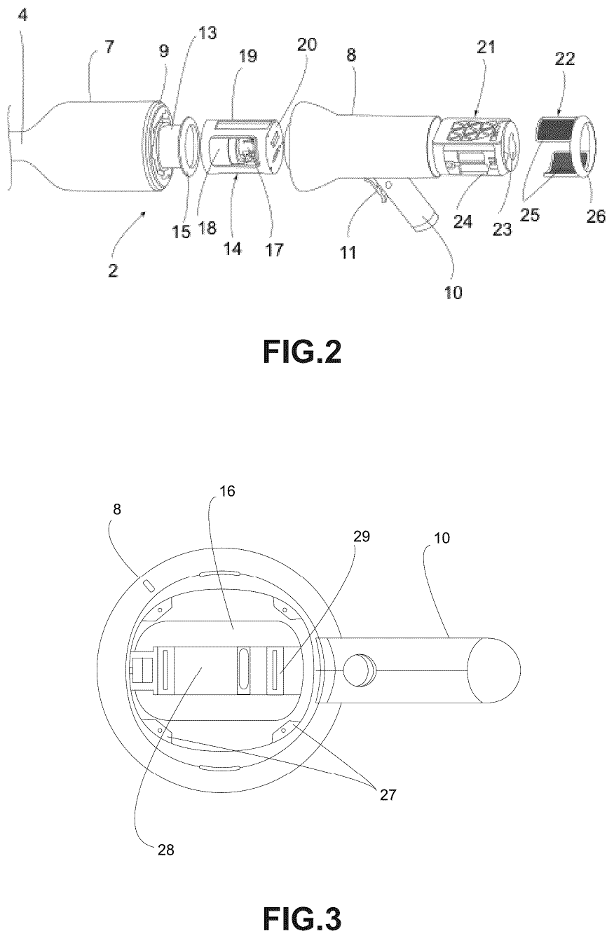

FIG. 2 shows the vacuum cleaner body 2 in an exploded view to reveal its internal components, based on an example of the invention. The vacuum cleaner body 2 comprises a substantially cylindrical tank 7. The lower end of the tank 7 is extended by the cylindrical opening 4 into which the suction tube 3 is inserted. The upper end of the tank 7 is mechanically connected to a central structure 8 acting as a frame for the entire stick vacuum cleaner 1. The tank 7 is mechanically connected to the central structure 8 by a first locking device 9 so that it can be easily assembled and disassembled without tools, i.e. manually. The first locking device 9 may be a mechanical bayonet lock, a quarter-turn lock, a magnetic lock or a combination of these locking modes. In this example, it is important that the tank 7 can be opened easily, as it must be emptied frequently of dust sucked up at the brush device 5 and collected in the tank 7.

In the example shown, the central structure 8 comprises a handle 10 arranged so that a user can ergonomically hold the stick vacuum cleaner 1 with one hand during use. The handle 10 comprises, for example, a trigger device 11 allowing the user to easily control the operation of the stick vacuum cleaner 1 during use.

A cyclonic filter block 12 (shown in FIG. 1) can be installed in the tank 7 to separate dust from the air sucked up from the floor by the stick vacuum cleaner 1. The dust can thus be collected in the tank 7 upstream of the cyclonic filter. It is understood that the terms “upstream” and “downstream” are to be understood in relation to the direction of air flow in the vacuum cleaner along the longitudinal axis of the stick vacuum cleaner 1 from bottom to top. The cyclone filter block 12 can then be inserted into the tank 7 without tools so that it can be easily removed for regular cleaning.

In one particular example, a HEPA filter 13 is arranged in the tank 7 downstream of the cyclone filter block. HEPA is an acronym for “high-efficiency particulate air”. The HEPA filter 13 treats the air flow leaving the cyclone filter block 12 to protect a motor block 14 located downstream of the HEPA filter 13.

In one particular example, the cyclone filter block 12 and the HEPA filter 13 form removable plug-and-play mechanical modules, i.e. they are easy to install in the stick vacuum cleaner 1 and are ready for use immediately after installation.

In one particular example, a motor block 14 is inserted from the front into the central structure 8. It is held in place inside the central structure 8 by a clamping collar 15. The clamping collar 15 is mechanically connected to the tank 7 by a second locking device (not shown) so that it can be easily mounted and removed without tools. This locking device may be a mechanical bayonet lock, a quarter-turn lock, a magnetic lock or a combination of these locking modes. The clamp 15 comprises a rubber part that rests on the motor block 14 to dampen vibrations and protect it from longitudinal shocks that the stick vacuum cleaner 1 may suffer, for example when the brush device 5 hits a piece of furniture or a wall. To enable a user to insert the motor unit 14 completely from the front into the central structure 8 and remove it easily, it is equipped with a retractable gripping device (not shown) which reduces the longitudinal dimensions of the motor module once it is in place in the central structure 8. The motor unit comprises an electric motor 17 driving a suction device 18, for example a propeller, in rotation. The motor module 14 carries its own control electronics, including the control functions and the fault diagnosis and fault prediction intelligence described below. This means that different motor models from different suppliers can be installed in the motor module 14, ensuring their compatibility with the other components of the stick vacuum cleaner 1.

In a particular example, the motor 17, its control electronics and the suction device 18 are encapsulated in a motor housing 19. The motor housing 19 comprises a motor connector 20 on its rear side, which is electrically connected to the electric motor 17. Thus, the motor unit 14 forms a removable plug-and-play electromechanical module (hereinafter referred to as the motor module), i.e. easy to mount in the central structure 8 of the stick vacuum cleaner 1 and directly operational after installation without requiring any electronic settings or adjustments to connect it to the other components of the stick vacuum cleaner 1.

In one particular example, a battery pack 21 is inserted from the rear into the central structure 8. It is held in place inside the central structure 8 by a fabric filter holder 22 which is mechanically connected to the rear end of the central structure 8 by a third locking device so that it can be easily assembled and disassembled without tools and thus the battery pack can be easily removed, for example for replacement. This third locking device may be a mechanical bayonet lock, a quarter-turn lock, a magnetic lock or a combination of these locking modes. The filter holder 22 comprises at least one fabric filter 25 (here two) and a metal ring 26 (or any other sufficiently rigid synthetic material). The metal ring 26 presses against the battery pack 21 to hold it in the rear part of the central structure 8.

In a particular example, the battery pack 21 comprises a rechargeable battery, for example of the lithium-ion type, a device for controlling the battery and certain functions of the stick vacuum cleaner 1, and a display 23 for viewing the status of the stick vacuum cleaner 1, for example in the form of pictograms. The battery control device comprises its own electronics, including the battery charging management functions and the fault diagnosis and fault prediction intelligence described below. Thus, different battery references from different suppliers can be mounted in the battery module 21, ensuring their compatibility with the other components of the stick vacuum cleaner 1.

In one particular example, the battery and its control device are encapsulated in a battery housing 24. The battery housing 24 comprises a display 23 on its rear side, which is electrically connected to the battery control device, and a battery connector (not shown) on its front side, which is electrically connected to the battery and the battery control device. The battery pack 21 thus forms a removable plug-and-play electronic module (hereinafter referred to as the battery module), i.e. easy to install in the central structure 8 of the stick vacuum cleaner 1 and directly operational after installation without requiring any electronic configuration or adjustment to connect it to the other components of the stick vacuum cleaner 1.

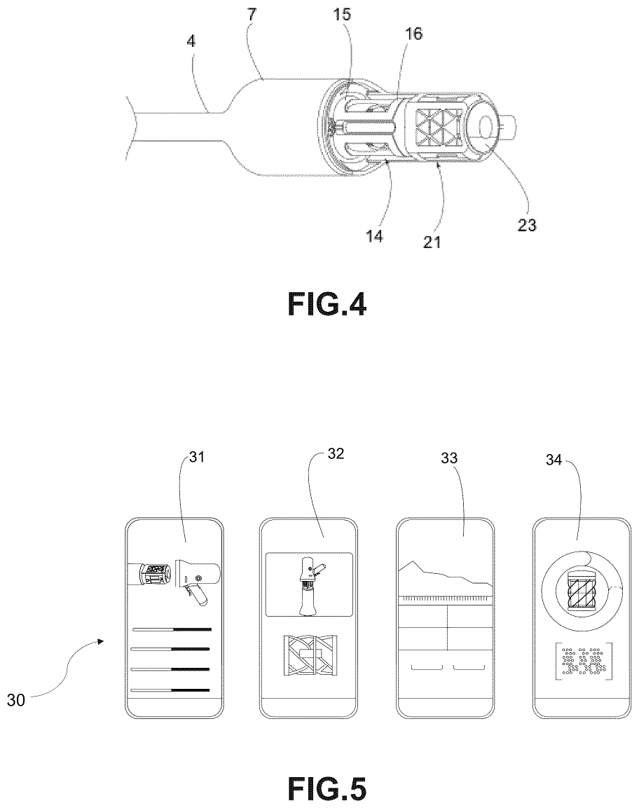

As illustrated in the example in FIG. 3, a PCB 16 (PCB is the acronym for “printed circuit board”) can be arranged in the central structure 8, for example so as to be fixed in the middle part of the central structure 8 on a plurality of tabs 27, here four, by screws. The PCB board 16 comprises, for example, on its front side (not shown) at least one front connector to which the motor connector 20 is connected when the motor module 14 is inserted from the front into the central structure 8. The PCB board 16 comprises, for example, on its rear side 28, at least one rear connector 29 to which the battery connector is connected when the battery module 21 is inserted from the rear into the central structure 8. Thus, the battery module 21 and the motor module 14 are connected in plug-and-play mode on either side of the PCB board 16, as shown in FIG. 4. The PCB board 16 also comprises a handle connector (not shown) facing downwards so that the handle 10, which is designed as an electromechanical module or as the receptacle for a specific module allowing, for example, the electronic functions relating to the control of the device by a user to be carried, can be connected to it when it is fixed to the central structure 8.

According to a particular example, the electromechanical module (i.e. the motor 14) and the electronic module (i.e. the battery module 21) are each equipped with at least one integrated sensor (not shown) specific to them, the function of which is to measure the performance of the module to which the sensor is associated during operation of the stick vacuum cleaner 1. In other words, the electronic module and the electromechanical module are each equipped with at least one sensor configured to (or capable of) performing performance measurements of the at least one corresponding module. For example, the motor module 14 may include at least one sensor for measuring performance of the motor module 14, and the battery module 21 may include at least one sensor for measuring performance of the battery module 21. In this way, each module can advantageously monitor its performance and transmit it independently of the other module(s) of the electromechanical device.

The performance measured by each sensor may vary in terms of nature, characteristics, number, etc. depending on the module concerned. For example, each performance measurement may define one or more characteristics or parameters (or capacities) of the module in question, such as motor speed (if the speed is zero, this may indicate a fault), motor temperature, battery temperature, power delivered by the battery, battery charge status, deviation from theoretical autonomy at full charge, etc.

In one particular example, the sensors of the various modules are electrically connected to the PCB 16 via the front and rear connectors (29). This allows PCB board 16 to centralise (or collect and/or process) information, including performance measurements, from (or provided by) the electronic and electromechanical modules (14, 21) and their sensors.

As described above, the modules mounted in the stick vacuum cleaner 1, in particular the battery module 21 and the motor module 14, comprise respectively an electronic device for controlling the electric motor 17 and an electronic device for controlling the battery. In addition to controlling the operation of the module, these electronic control devices implement diagnostic and predictive functions for the status of at least one of the modules of the stick vacuum cleaner. Thus, in addition to their specific functional aspects, each of the modules comprises all the features necessary to ensure the other features of the invention described below, such as diagnosing the status of the module and predicting changes in that status.

The stick vacuum cleaner 1 is advantageous in that it allows for easy maintenance and/or upgradeability by a non-expert while preserving the performance and reliability (in particular the longevity) of the device. In this way, the obsolescence of such a device can be effectively combated, whether it be obsolescence due to use or technological obsolescence, as already indicated. In particular, it is possible for a user to easily repair or improve part of the electromechanical device (e.g. a defective part or a part that needs to be modified) at the appropriate time, for example, preventively before performance degradation or before a breakdown occurs, or curatively when a breakdown or defect occurs, or when the performance of the device is no longer suitable for the context of use.

For example, it is advantageously possible to improve the performance of the stick vacuum cleaner 1 by modifying a module, such as the battery module and/or motor module, in order to meet new usage requirements (e.g. a new usage environment requiring adaptation of the performance of the module(s)). A non-expert user can thus easily ensure the scalability of the electromechanical device by replacing one or more modules assembled in the central structure 8.

The modular construction within the central structure 8 also provides effective protection for the modules of the stick vacuum cleaner 1, in particular against dust and shocks, while allowing each module to be replaced independently and selectively, so that maintenance and/or upgrades can be carried out as required.

The invention can also be advantageously used to detect faults, breakdowns or any performance drops (transient or prolonged) in the modules of the stick vacuum cleaner 1, thereby enabling even non-expert users to determine which module needs to be replaced and when (e.g. before or after a breakdown or other event). Maintenance or servicing operations can, for example, be announced preventively or curatively so that the user can identify and, if necessary, replace the appropriate module with another at the appropriate time.

According to a particular example, the stick vacuum cleaner 1 forms, with a third-party terminal 30, a system, also known as a regeneration system. This system allows the stick vacuum cleaner 1 to be regenerated (or improved, maintained, repaired), kept in working order, or upgraded. The third-party terminal 30 is, for example, a computer, smartphone or tablet. An application, hereinafter referred to as a dedicated application, is installed on this third-party terminal 30. This application (or computer program) can be executed by at least one processor (not shown) of the terminal 30.

In a particular example, the application is configured to receive, via a wireless link, an alert signal generated from performance measurements from the sensors, and to instruct the third-party terminal 30 to generate a first notification to a user and/or a second notification transmitted by the third-party terminal 30 to a user profile on a website and/or to the user's email inbox.

According to a particular example, if the alert signal corresponds to a first state requiring maintenance, the application provides the user with a tutorial procedure (or tutorial information, or usage information) on the third-party terminal 30 to perform maintenance or servicing of the electromechanical device 1.

According to a particular example, if the alert signal corresponds to a second state requiring a fault prevention operation, the application authorises the user to (or allows the user to) order a replacement module.

According to a particular example, if the alert signal corresponds to a third state requiring a fault repair operation, the application authorises the user to (or allows the user to) order a replacement module.

According to a particular example, the PCB board 16 can also be electrically connected to the screen 23 located at the rear of the battery module 21 via the rear connector 29. The PCB board 16 includes a transceiver (transmitter/receiver) for establishing a wireless connection, for example of the Bluetooth™, Wi-Fi, 4G, 5G type, etc. For example, for a Bluetooth™ connection, the transceiver is connected to a Bluetooth™ antenna integrated into the handle 10. The PCB board 16 can then transmit information from the battery module 21 and the motor module 14 to the screen 23 and/or the third-party terminal 30 via the Bluetooth™ antenna. The third-party terminal may be, for example, a computer, smartphone or tablet. A smartphone is shown as an example of implementation in FIG. 5, on which a dedicated application is installed. The Bluetooth™ wireless connection may be replaced or combined with a WiFi wireless connection or any other wireless connection as indicated above.

The information transmitted by PCB board 16 via wireless connection to the third-party terminal can also generate notifications relating to the status of stick vacuum cleaner 1, which are sent to the user from the dedicated app and/or by email, possibly via a dedicated server.

The stick vacuum cleaner 1 described above can thus advantageously feature an entirely or at least partially modular architecture. This plug & play modularity, as explained above, advantageously allows the user to access the main electronic, electromechanical or mechanical components of the device without the aid of tools. As illustrated in particular in FIG. 1, the electronic or electromechanical modules (motor module 14, battery module 21, handle 10) and the mechanical modules (tank 7, suction tube 3, brush device 5) can be pre-assembled together on a plug & play basis. In one particular example, the architecture of the stick vacuum cleaner 1 is of the chassis type, i.e. composed of a central structure 8 designed to accommodate electronic modules, electromechanical modules and mechanical modules with different performances, each performing specific functions.

In one particular example, the electronic or electromechanical modules (motor module 14, battery module 21, handle 10) and the mechanical modules (tank 7, suction tube 3, brush device 5) are assembled without glue in the central structure 8 serving as a frame.

If unusual module behaviour is detected by one of the sensors, for example overheating, under-speed or over-speed of the electric motor 17, an alert signal can be advantageously generated by the PCB board 16 and an alert can be given, for example by displaying a pictogram on the screen 23 of the stick vacuum cleaner 1. For this purpose, performance values can be predefined for each of the sensors and, when the measurement of one of the sensors is outside the predefined values, an alert signal representative of the situation is generated. The alert signal can also be generated by a more complex algorithm that cross-references the performance values delivered by several sensors and which can integrate an artificial intelligence learning function. This alert signal can also be transmitted, for example via a Bluetooth™ wireless connection, from the stick vacuum cleaner 1 to one or more of the third-party terminals mentioned above on which the dedicated app is installed. It can appear there in the form of a notification that can also be sent to the user's web account profile and email inbox. This alert (called “Predictive Maintenance Assistant”) can cover at least three types of situations requiring user intervention.

On the one hand, this alert may correspond to a maintenance situation in order to prevent a breakdown. In this case, the user can access a tutorial procedure (photo, diagram, video) on the third-party terminal to assist them in the maintenance procedure for their device. For example, if the sensor on motor module 14 detects that electric motor 17 is over-revving, the user is prompted to empty dust from tank 7 and clean the various filters on the vacuum cleaner, such as cyclonic filter block 12, HEPA filter 13 and fabric filter 25.

On the other hand, the alert may correspond to a predictive failure situation, i.e. the imminent occurrence of a failure. According to a first example, if the sensor of motor module 14 detects an unusual under-speed or overheating of electric motor 17, the user is prompted to order a replacement motor module 14 from the dedicated app on one of the third-party terminals, or directly from the website of the manufacturer of the stick vacuum cleaner 1, and to replace the faulty motor module 14. In a second example, if the sensor of battery module 21 detects a significant drop in the battery's charge capacity, the user is prompted to order a replacement battery module 21 from the dedicated app on one of the third-party terminals, or directly from the website of the manufacturer of stick vacuum cleaner 1, and to replace the defective battery module 21. The user is informed of the status of the stick vacuum cleaner 1 and what to do on screen 23 by pictograms and on the third-party terminals to which the vacuum cleaner is connected by notifications and/or pictograms visible on the dedicated app installed on them.

The alert may also correspond to an actual fault rendering the appliance wholly or partially inoperable, requiring replacement of the faulty module in order to restore the appliance to full capacity.

In the event of a damaged or defective mechanical module, such as the cyclonic filter block 12 or the tank 7, the user can go to the dedicated app on one of the third-party devices connected to the stick vacuum cleaner 1, or to their dedicated web profile, to order the defective mechanical module and replace it with a new corresponding mechanical module.

Thus, the stick vacuum cleaner 1, the third-party terminal(s) connected to the vacuum cleaner and the dedicated app installed on the third-party terminals form a system that advantageously prevents breakdowns caused by a lack of maintenance or allows a defective module to be replaced preventively before a breakdown occurs. This system thus advantageously allows electromechanical or electrical appliances, such as a stick vacuum cleaner 1, to be easily regenerated and maintained in working order in order to combat obsolescence while preserving the performance and reliability of these appliances, in particular by protecting the components of these appliances from dust or other contaminants. It is also advantageously possible to replace a module when its performance no longer meets requirements or is no longer suitable for the context of use (e.g. in the event of a change in the environment or context of use).

All modules and their variants are available on the dedicated website and on the dedicated app. As shown in FIG. 5 via the dedicated app or the dedicated website, the user can access a configuration panel 31 for their stick vacuum cleaner (also known as the “modular system configurator”). The user is asked to enter information about the context in which they intend to use the vacuum cleaner they wish to purchase, for example, the size of their home, the type of flooring, whether they have pets, whether they own a vehicle, etc. This information is used to identify the stick vacuum cleaner configuration best suited to their needs. For example, the battery life of battery module 1 is adapted to the size of the home, and the power of the electric motor in motor module 14 is adapted to the type of flooring and whether the user has pets.

According to a particular example, all electronic modules available on the dedicated app and website include information on their nominal usage guarantee, which is calculated in advance by the manufacturer with or without taking into account the information entered by the user on the configuration panel. Therefore, if a module fails before the end of its nominal usage period, the user can order a replacement module free of charge. Conversely, if the nominal usage guarantee period has expired, the user will have to pay the cost of the replacement module when ordering it.

As illustrated in FIG. 5, based on a particular example, the dedicated application installed on the third-party terminal displays a tutorial panel 32 to assist the user in removing or installing the module to be serviced or replaced. A maintenance or fault alert panel 33 informs the user of upcoming maintenance operations and warns them that a module is faulty and that a fault is likely to occur. This means that the user no longer experiences faults due to a lack of maintenance or interruptions in operation due to a faulty module that has stopped working.

In one particular example, packaging used by the manufacturer to send a replacement module to the user's home can be pre-paid so that the user can return the replaced defective module. This means that the packaging for the modules is reusable and the electronic and electromechanical modules are returned by the manufacturer of the stick vacuum cleaner 1 to recycling centres or suppliers for reconditioning. A recycling panel 34 is available on the dedicated app or website to enable users to easily return a defective module and ensure that it is recycled or reconditioned.

The system for regenerating an electromechanical device or a stick vacuum cleaner 1 described above can be implemented according to a method, referred to as the regeneration method, a particular example of which is described below with reference to FIGS. 1 to 5. First, a user can access a configuration panel 31 available in the dedicated application on a third-party terminal 30 in order to configure the stick vacuum cleaner 1 (e.g. a stick vacuum cleaner that they wish to purchase) in the best possible way according to their needs. In other words, the user is provided with access, on the third-party terminal 30 via the application, to the configuration panel 31 of the stick vacuum cleaner 1. The user enters information relating to the context of use of the stick vacuum cleaner 1. The application thus obtains the context information entered by the user. Based on this information, the dedicated application determines a configuration for the stick vacuum cleaner 1 by identifying (or selecting), from among available electronic and electromechanical modules, the at least one electronic module (e.g. the battery module 21) and the at least one electromechanical module (e.g. the motor module 14) that are most appropriate according to the usage context. Thus, the application can configure the stick vacuum cleaner 1 by identifying, from the range of available electronic or electromechanical modules, those that are most appropriate for its use, for example the battery module whose autonomy is best suited to the context of use of the stick vacuum cleaner 1, and, thanks to its modular design, offer the stick vacuum cleaner 1 in the configuration best suited to its use.

As explained above, when stick vacuum cleaner 1 is in operation, the performance of battery module 21 and motor module 14 can be measured by sensors fitted to each of these modules. An alert signal is generated if one or more of the sensors measure performance of the corresponding module that does not comply with predefined values (e.g. standard values) or that is detected as abnormal by the algorithm, which may include an artificial intelligence learning function. This alert signal can then be transmitted to a device for signalling the status of the electronic device or the vacuum cleaner, which may, for example, comprise a display 23 or a transceiver configured to establish a wireless connection with one or more third-party terminals 30 connected to the stick vacuum cleaner 1 as already described above.

In other words, according to a particular example, the method comprises:
performing performance measurements of the at least one electronic module, such as the battery module 21, and the at least one electromechanical module, such as the motor module 14, by the at least one sensor equipping each of said modules;
generating an alert signal by said at least one sensor if the performance of the corresponding module does not comply with predefined values (e.g. standard values) or does not comply according to an algorithm that can integrate a learning function; and
transmitting said alert signal to a device for signalling the status of the electromechanical device.

Thus, according to a particular example of implementation of the method, the alert signal is transmitted to a screen 23 located in a position clearly visible to the user on the battery module 21, and by wireless connection to a dedicated application installed on a third-party terminal or to a dedicated website.

The alert signal then conveniently displays on the screen and third-party terminal at least three situations corresponding respectively to a first state requiring maintenance, a second state requiring breakdown prevention, and a third state requiring breakdown repair. To perform the maintenance operation, the user is prompted to access the assigned module to perform a maintenance operation, assisted by a tutorial procedure provided on the dedicated application or website. To perform the breakdown prevention operation, the user is invited to order a replacement module on the dedicated app or website so that it can be substituted for the defective module, thereby preventing a breakdown and keeping the stick vacuum cleaner 1 in optimal operating condition. To perform the fault repair operation, the user must order a replacement module on the dedicated app or website so that it can be substituted for the faulty module, thereby restoring the full functionality of the faulty stick vacuum cleaner.

Thus, according to a particular example of the regeneration method, the alert signal is transmitted to a screen 23 located on the stick vacuum cleaner 1 (for display on the screen), and/or to an app installed on a third-party device 30, so that at least one of the following can be viewed:
a first state requiring a maintenance operation for which a user is prompted to access the affected module to perform a maintenance operation, a tutorial procedure may then be offered to assist the user in performing the operation;
a second state requiring a fault prevention operation for which the user is prompted to order a replacement module on the application to replace the faulty module; and
a third status requiring a breakdown repair operation, for which the user must order a replacement module on the application to replace the faulty module.

The method may be supplemented by information relating to a nominal usage guarantee for each of the battery, motor or mechanical modules available, which is stored on the dedicated app and/or website. Thus, if a faulty module breaks down before the expiry of a guaranteed period of use, the corresponding replacement module can be ordered, for example free of charge.

The system for regenerating an electromechanical device or the stick vacuum cleaner 1 described above also comprises a computer program product comprising code instructions for implementing the method described above. In particular, the application running on the third-party terminal 30 may constitute a computer program comprising instructions which, when executed by a processor of the third-party terminal 30, cause the steps of the regeneration method to be carried out.

As indicated in the above description, the various aspects of the invention may be implemented according to the context in configuration variants different from those described above. For example, other household appliances or power tools may be produced according to the invention and form a system enabling their regeneration in order to prevent their obsolescence, for example a blender or a drill.

Naturally, the invention is described above by way of example. It is understood that a person skilled in the art is capable of realising different variants of the invention without departing from the scope of the invention.

It should be emphasised that all the features, as they appear to a person skilled in the art from the present description, the drawings and the attached claims, even if they have only been described in relation to other specific features, either individually or in any combination, may be combined with other features or groups of features disclosed herein, provided that this has not been expressly excluded or that technical circumstances render such combinations impossible or meaningless.

1. An electromechanical device comprising a central structure having assembled therein at least one electronic device electrically connected to at least one electromechanical device, said at least one electronic device enabling at least one of supplying electrical energy and controlling said at least one electromechanical device, said electromechanical device in which:
the at least one electronic device and the at least one electromechanical device are respectively arranged in the form of at least one removable electronic module at least one removable electromechanical module;
the at least one electronic module and the at least one electromechanical module respectively include a control device integrated into the respective module for said electronic device and said electromechanical device; and
the at least one electronic module and the at least one electromechanical module being assembled in the central structure and are electrically connected to each other without tools and in such a way as to be directly operational after assembly.

2. The electromechanical device according to claim 1, wherein the central structure forms a frame in which the at least one electronic device and the at least one electromechanical device are assembled.

3. The electromechanical device according to claim 1, wherein the at least one electronic module and the at least one electromechanical module are each equipped with at least one sensor capable of measuring performance of the corresponding at least one module,
the control devices integrated respectively into said modules being configured to implement, based on the performance measurements, diagnostic and predictive functions generating an alert signal when the performance of the corresponding module measured by said at least one sensor does not comply with predefined values or by an algorithm that can integrate a learning function; and to transmit said alert signal to a signalling device for signalling a status of said module.

4. The electromechanical device according to claim 3, wherein said alert signal is representative of at least one of:
a first state requiring a maintenance operation;
a second state requiring a fault prevention operation; and
a third state requiring a failure repair operation.

5. The electromechanical apparatus according to claim 3, wherein said signalling device includes at least one of:
a display located on the electromechanical device and electrically connected to said at least one electronic module; and
a transceiver for establishing a wireless connection with a third-party terminal independent of the electromechanical device, such as a tablet or smartphone, and/or a server capable of generating at least one of a notification from an application or by email.

6. The electromechanical device according to claim 3, wherein said electromechanical device is a power tool or a household appliance;
and wherein said at least one electronic module includes a battery module comprising a rechargeable battery, and wherein said at least one electromechanical module includes a motor module comprising an electric motor device electrically powered by the battery module.

7. The electromechanical apparatus according to claim 6, further comprising at least one mechanical module assembled in the central structure so as to be functionally connected to the at least one electromechanical module without tools and in such a way as to be directly operational after assembly.

8. The electromechanical device according to claim 7, wherein:
the at least one electronic module, said the at least one electromechanical module and the at least one mechanical module are assembled in said central structure and are electrically or functionally connected to each other without tools and in such a way as to be directly operational after their assembly in the central structure; and
the at least one electronic module is configured to supply power to the device; and
at least one mechanical module comprises at least one filter module.

9. The electromechanical apparatus according to claim 6, wherein the electromechanical apparatus is a stick vacuum cleaner.

10. The electromechanical apparatus according to claim 9, wherein:
the at least one sensor of the battery module is configured to measure a temperature or a charge capacity of the battery;
the at least one sensor of the motor module is configured to measure a temperature or rotational speed of the electric motor; and
the signalling device is configured to generate, in response to said alert signal, an alert in the form of a pictogram or a notification.

11. The electromechanical device according to claim 4, wherein:
the first state requires a maintenance operation for which a user is prompted to access the affected module to perform a maintenance operation, such as emptying a dust container and cleaning the at least one filter when the at least one sensor of the motor module detects an overspeed;
the second state requires a fault prevention operation for which the user is prompted to order a replacement battery module to replace the faulty battery module before it becomes inoperable, when the at least one sensor of the motor module detects an under-speed of the electric motor, or to order a replacement motor module to replace the faulty battery module, if the at least one sensor of the motor module detects overheating of the electric motor; and
the third state requires a repair operation to restore the full functionality of a faulty module.

12. The electromechanical device according to claim 9, wherein said electromechanical device further comprises a PCB board arranged in a housing provided in said central structure and having on a front face at least one front connector and on a rear face at least one rear connector; and wherein:
the motor module is inserted from the front into said housing to connect to the at least one front connector of said PCB board, or
the battery module is inserted into said housing from the rear to connect to the at least one rear connector of said PCB board;
the PCB board being configured to centralise information, including performance measurements, from the battery and motor modules, and to transmit each alert signal to said signalling device.

13. The electromechanical device according to claim 12, further comprising:
a display electrically connected to said PCB board, arranged on said stick vacuum cleaner, preferably on a visible part of said battery module once it is inserted into said housing, and on which the status of the stick vacuum cleaner is indicated by pictograms; and
a transceiver electrically connected or integrated with said PCB board and electrically connected to an antenna located on said central structure, preferably in a handle, in order to be able to communicate with a said third-party terminal.

14. A regeneration system comprising:
an electromechanical device according to any of claim 1; and
a third-party terminal being one of a computer, a smartphone or a tablet, on which an application is installed,
the application being configured to receive a said alert signal, produced based on the performance measurements, via wireless communication, and to command said third-party terminal to generate at least one of a first notification to a user, and a second notification transmitted by the third-party terminal on a user profile of a website or in a user's mailbox.

15. The system according to claim 14, wherein:
if the alert signal corresponds to a first state requiring a maintenance operation, the application provides the user with a tutorial procedure on the third-party terminal for servicing or maintaining said electromechanical device;
if the alert signal corresponds to a second state requiring a fault prevention operation, the application authorises the user to order a replacement module, and
if the alert signal corresponds to a third state requiring a fault repair operation, the application authorises the user to order a replacement module.

16. The system according to claim 14, wherein:
the application is configured to provide a user with access through the application to a configuration panel of the electromechanical device for entering information relating to a usage context of the electromechanical device, and for configuring the electromechanical device by selecting modules adapted to the usage context; or
the application is configured to cause storage of information relating to a nominal usage warranty for at least said module.

17. A method of implementing a regeneration system according to claim 1 for regenerating said electromechanical device, said method comprising:
providing a user with access to a configuration panel of the electromechanical device on said third-party terminal through an application;
obtaining, via the configuration panel, information relating to a context of use of the electromechanical device; and
determining, by the application, based on the information relating to the context of use, a configuration of the electromechanical device by identifying, from among available electronic and electromechanical modules, the at least one electronic module and the at least one electromechanical module that are most appropriate according to the context of use, for example the battery module whose autonomy is most suited to the context of use of said electromechanical device.

18. The method according to claim 17, wherein the method comprises, during operation of the electromechanical device:
performing performance measurements of the at least one electronic module, such as the battery module, and the at least one electromechanical module, such as the motor module, by at least one sensor equipping each of the modules;
generating an alert signal by the at least one sensor if the performance of the corresponding module does not comply with predefined values or by an algorithm capable of integrating a learning function; and
transmitting the alert signal to a signalling device for signalling the status of the electromechanical device.

19. The method according to claim 18, wherein said alert signal is transmitted to a screen located on the electromechanical device, and to an application installed on a third-party terminal, so as to enable the display of at least one of:
a first state requiring a maintenance operation for which a user is prompted to access the affected module to perform a maintenance operation, a tutorial procedure is provided to guide the user in performing the operation;
a second state requiring a fault prevention operation for which the user is prompted to order a replacement module on the application in order to replace the faulty module; and
a third state requiring a fault repair operation for which the user must order a replacement module on the application to replace the faulty module.

20. A non-transitory storage medium storing a computer program product comprising code instructions. which when executed implement the method of claim 17.
